(19) United States
(12) Patent Application Publication
(10) Pub. No.: US 2008/0144543 A1
(43) Pub. Date: Jun. 19, 2008

(54) Time division duplex forward-to-reverse transition signal generator

(76) Inventors: Matthew J. Hunton, Liberty Lake, WA (US); Scott Carichner, Rancho Santa Margarita, CA (US)

Correspondence Address: MYERS DAWES ANDRAS & SHERMAN, LLP, 19900 MACARTHUR BLVD., SUITE 1150, IRVINE, CA, 92612, US

(21) Appl. No.: 12/001,397

(22) Filed: Dec. 11, 2007

Related U.S. Application Data
(60) Provisional application No. 60/874,557, filed on Dec. 13, 2006.

(51) Int. Cl. H04J 3/00

(52) U.S. Cl. 370/280; 370/294

(57) ABSTRACT

A transition signal generator is used to for controlling a booster of a time division duplex signal in a communications system. The transition signal generator includes a signal sampler for sampling the time division duplex signal, a power detector for detecting a power of the sampled signal, and a timing control unit for generating a logic signal indicating a direction of the sampled signal from the detected power of the sampled signal.

### CROSS-REFERENCE TO RELATED APPLICATION

The present application claims priority under 35 USC section 119(e) to U.S. Provisional Patent Application Ser. No. 60/874,557, filed Dec. 13, 2006, the disclosure of which is herein incorporated by reference in its entirety.

### BACKGROUND OF THE INVENTION

1. Field of the Invention

The present invention relates generally to wireless communications systems and methods. More specifically, the invention relates to time division duplex wireless communications systems and methods.

2. Description of Related Art

Many modern wireless communication systems are moving to Time Division Duplex (TDD) to provide two-way communication between a base station and remote stations. In TDD systems, the same carrier frequency is used for both base-to-remote and remote-to-base radio links. These links are generally referred to as forward and reverse radio links, respectively. The two radio links share the same carrier frequency by alternately sharing the link in time. For a particular coverage area, the base station equipment will have one port supporting both forward and reverse links. This port will be connected to an antenna. The forward link will include sufficient power to reach remote stations. The reverse link must be capable of receiving low power signals from remote stations.

Base station manufacturers build equipment for various site deployment scenarios. Each site may differ in the amount of required forward power. The forward power required is determined by the size of the coverage area, and transport loss (generally coaxial cable) from the base station to the antenna. Since both the forward and reverse links share the same signal path, this transport loss also complicates the reverse link. Transport loss increases reverse link noise figures thus reducing the reverse link coverage area. Base station manufacturers attempt to balance these various site needs while at the same time keeping the number of base station variants to a minimum.

Given the base station variants available from manufacturers, some site requirements may still not be met in a cost effective way. This gives an opportunity for third party equipment suppliers to provide base station augmenting equipment. Such equipment is generally referred to as a booster. Boosters can include forward link power amplifiers, reverse link low noise amplifiers, or both. Boosters however are generally add-on devices with little or no coordinating communication with the base station equipment. This presents a problem when adding booster equipment to TDD base stations.

Generally a booster product is simply connected in the radio frequency (RF) signal path from the base station to the antenna. As previously stated, a booster can amplify the forward, the reverse, or both, links. To do this, however, the forward and reverse links must be isolated from the common signal path which shares both the forward and reverse link in time. Conventionally this must be done using separate data information from the base station regarding when the common signal path is used by the forward link or conversely the reverse link. FIG. 1 shows a block diagram of such an approach in a system including a base station 105, a booster 130, and an antenna 140. The base station 105 operates with a TDD signal link connected on path 110. The base station 105 also has a logic signal output 145. This logic signal output 145 is at one logic state to indicate when the TDD signal path 110 is transmitting the forward signal, and another logic state when the TDD signal path 110 is receiving the reverse signal. The synchronous nature of these two signals permits the booster to switch from a forward signal boosting state to a reverse signal boosting state in order to produce optimal performance in both states. Without the logic signal 145 from the base station 105, the booster 130 would not provide optimal performance for either forward or reverse signals.

In general however, this approach is not suitable since the separate data information from the base station regarding when the common signal path is used by the forward link, or conversely the reverse link, is not available. This information is often intentionally withheld by base station equipment providers to prevent augmenting base stations with third party equipment.

Accordingly a need presently exists for a system and method to optimize booster performance when separate data information from the base station regarding when the common signal path is used by the forward link, or conversely the reverse link, is not available.

### SUMMARY OF THE INVENTION

In one aspect, embodiments of the invention provide a transition signal generator. The transition signal generator includes a signal sampler for sampling a time division duplex signal from a signal path in a communications system, a power detector for detecting a power of the sampled signal, and a timing control unit for generating a logic signal indicating a direction of the sampled signal from the detected power of the sampled signal.

In one embodiment, the signal sampler includes a directional coupler. The timing control unit generates the logic signal based on the rising or falling edge of the detected power of the sampled signal. The logic signal may be offset in time from the edge of the detected power of the sampled signal, for example, by one or more periods less a detection delay. Preferably, the logic signal is offset by one period less the detection delay. The timing control unit further generates the logic signal based on the width between rising and failing edges of the sampled signal. The width of the logic signal is preferably greater than the width of the sampled signal. The sampled signal from the signal path may a forward signal power substantially higher than a reverse signal power.

In another aspect, embodiments of the invention provide a wireless communication system. The system includes a base station, an antenna for outputting a forward signal from, or feeding a reverse signal to, the base station on a time division duplex basis, a booster coupled between the base station and the antenna for boosting at least one of the forward and the reverse signal, and a transition signal generator coupled to the base station and the booster to sample a time division duplex signal between the base station and the antenna and to control the booster, the transition signal generator including a signal sampler for sampling the time division duplex signal between the base station and the antenna, and means for generating a logic signal indicating a direction of the sampled signal to control the booster.

In one embodiment, the booster selectively boosts the forward signal or the reverse signal based on the logic signal generated by the transition signal generator. The time division duplex signal may include a forward signal, a reverse signal, and a reverse to forward gap between the forward signal and the reverse signal. The forward signal may have substantially higher power than the reverse signal.

In one embodiment, the signal sampler includes a directional coupler. The transition signal generator may further include a power detector for detecting a power of the sampled signal. The power detector is preferably a logarithmic power detector. The transition signal generator determines whether the signal is forward or reverse based on the detected power of the sampled signal.

In another aspect, embodiments of the invention provide a method for controlling a booster of a time division duplex signal between a base station and an antenna. The method includes sampling the time division duplex signal, determining a signal direction as being forward or reverse based on the sampled signal, and controlling the booster based on the determined signal direction.

The time division duplex signal may include a forward signal, a reverse signal, and a reverse to forward gap between the forward signal and the reverse signal. The forward signal has a substantially higher power than the reverse signal. In one embodiment, the method further includes detecting a power of the sampled signal and determining the signal direction is based on the detected power of the sampled signal. The method may further include outputting a logic signal indicating the signal direction, wherein the logic signal timing is based on the detected power of the sampled signal. The method may further include adjusting the logic signal timing to compensate for a delay of the sampled signal relative to the time division duplex signal.

In one embodiment, the logic signal is offset in time from the detected power of the sampled signal, for example, by one or more periods less a detection delay. Preferably, the logic signal is offset by one period less the detection delay. The logic signal is preferably based on the width and a rising edge period of the detected power of the sampled signal.

Further aspects of the construction and method of operation of the invention, with additional objects and advantages thereof, will be best understood from the following description of specific embodiments when read in connection with the accompanying drawings.

### BRIEF DESCRIPTION OF THE DRAWINGS

The characteristics and advantages of the present invention will be better understood from the following description in conjunction with the attached drawings.

FIG. 1 is a block diagram of a prior art time division duplex base station utilizing a booster.

FIG. 2 is a block diagram of a time division duplex base station utilizing a forward-to-reverse transition signal generator and a booster.

FIG. 3 is a block diagram of the forward-to-reverse transition signal generator.

FIG. 4A is a timing diagram for the forward signal and the reverse signal found on a common transmission path.

FIG. 4B is a timing diagram for the forward power detection as measured by the forward-to-reverse transition signal generator.

FIG. 4C is a timing diagram for the generated forward-to-reverse transition signal recovered by the present invention.

FIG. 5 is block diagram of an exemplary booster.

### DETAILED DESCRIPTION OF THE INVENTION

The present invention addresses the above problem and provides a system and method which generates a forward-to-reverse link transition signal by monitoring the common line. This link transition signal can then be provided to a TDD booster thereby enabling booster operation. Accordingly the present invention also provides an improved base station and transmitter equipped with a booster.

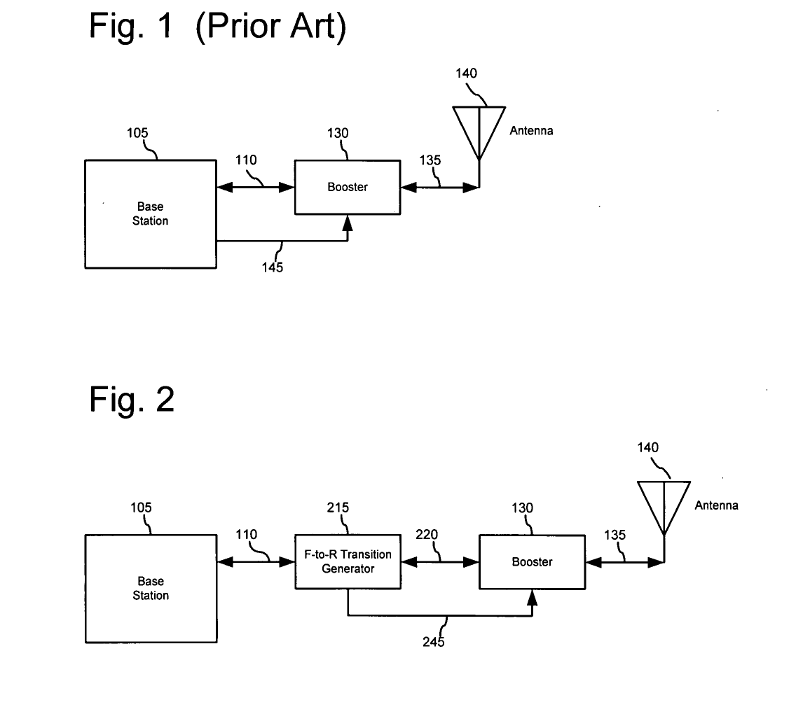

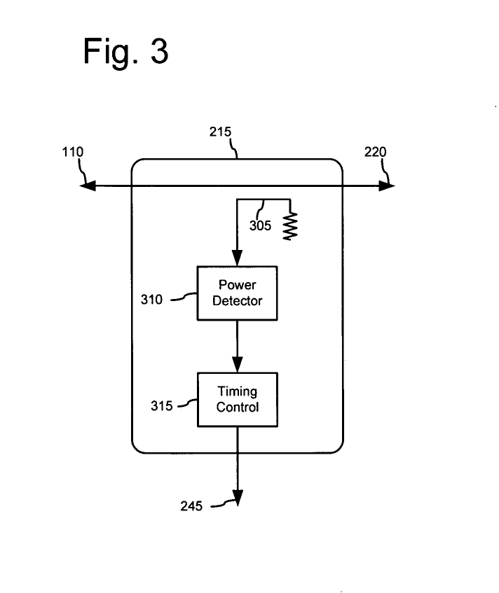

FIG. 2 is a block diagram including a base station 105, a forward-to-reverse transition signal generator 215, a booster 130, and an antenna 140. The base station 105 in FIG. 2 does not include a logic signal output, or the logic signal output is not used. As before, the base station 105 operates with a TDD signal link connected on path 110. The base station TDD signal link is connected to a forward-to-reverse (F-to-R) transition signal generator 215. The TDD signal link passes through the signal generator 215 without modification, but perhaps with some attenuation, for connection to the booster 130 via signal path 220. The forward-to-reverse transition signal generator 215 also creates a logic signal output on path 245. This logic signal output 245 is at one logic state to indicate when the TDD signal path 220 is transmitting the forward signal, and another logic state when the TDD signal path 220 is receiving the reverse signal. The forward-to-reverse transition signal generator 215 then provides the TDD signal link on path 220 and the synchronous logic signal on path 245 to the booster 130. The booster 130 then operates as described above for the system of FIG. 1.

FIG. 3 shows a block diagram of the forward-to-reverse transition signal generator 215. The signal generator 215 includes a signal sampler 305, such as a directional coupler or other well known samplers such as a Wilkinson splitter, a power detector 310, and a timing control unit 315. The directional coupler 305 samples signals entering from port 110 and exiting from port 220. The signal passing through the signal generator 215 in this direction is the forward signal. The forward signal is then power detected by the power detector 310. Any type of power detectors may be used in this application. However, a logarithmic power detector is generally preferred. By using a logarithmic power detector, the dynamic range of the signal generator 215 with respect to forward link signal power can be made larger. The power detector 310 also includes detected power filtering. Whenever possible, the filter bandwidth should be broad enough to pass the bandwidth of the signal transitions from forward-to-reverse, but narrow enough to filter off the power fluctuations of the forward signal due to modulation by information. The output of the power detector 310 is then fed to a timing control unit 315. The timing control unit 315 samples the output of the power detector 310. These samples are then digitally processed by the timing control unit 315 to determine an appropriate synchronous logic signal for use by the booster 130 on path 245.

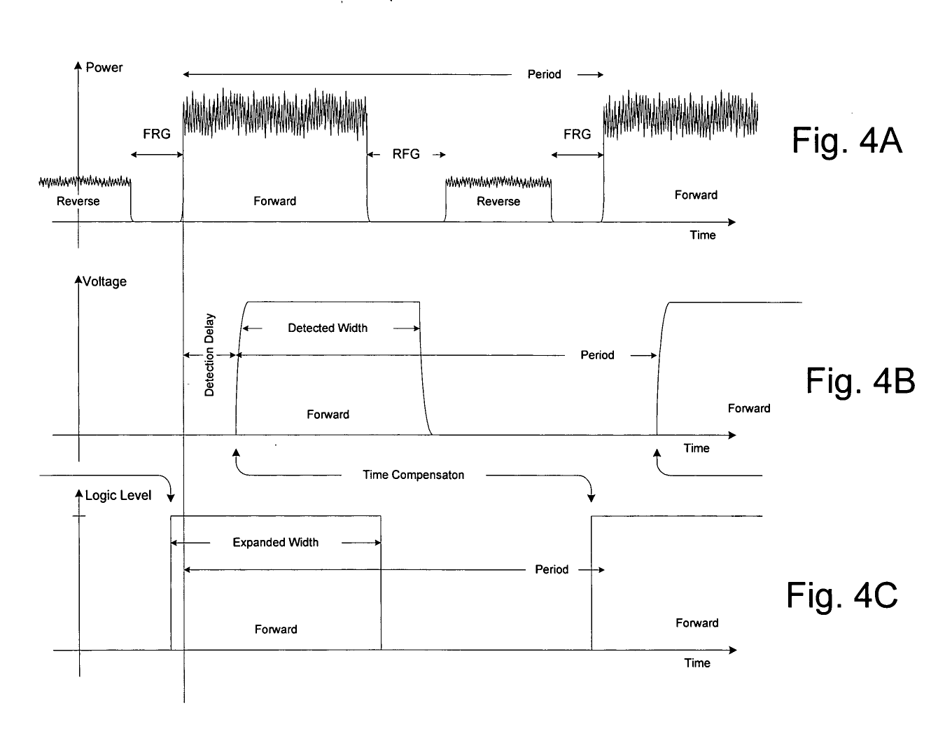

FIG. 4A shows a timing diagram of the TDD signal found on signal paths 110, 220. FIG. 4B shows the power detected by power detector 310 after coupling by the directional coupler 305. FIG. 4C shows a logic signal generated by timing control unit 315 based on samples taken from the power detector 310 output. FIG. 4A illustrates how the TDD signal is constructed from four parts. There is the forward signal, a forward-to-reverse signal gap (FRG), the reverse signal, and a reverse-to-forward gap (RFG). These four parts repeat on a periodic basis based on the rising edge of the forward signal. It should be noted that the reverse signal in FIG. 4A is shown artificially high for illustrative purposes only.

FIG. 4B shows the output of the power detector 310. The rising edge of the detected forward signal is delayed from the detected edge of the actual forward signal. This delay includes that of the directional coupler 305, power detecting circuits found within the power detector 310, and filtering circuits found within the power detector 310. Note that the filtering circuits within the power detector 310 have removed power fluctuation due to forward signal modulation by information. FIG. 4B shows no residual fluctuations. However, some residual power fluctuation due to information modulation is expected and will not impair the operation of embodiments of the present invention. Note also that the power detector output does not show any output representing the reverse signal. In an actual system, some residual reverse signal detection may be present at the output of the power detector at low levels. These reverse detected levels will be low due to the fact that the forward signal is much higher in amplitude than the reverse signal on signal paths 110, 220, and because the directional coupler will further reduce the reverse signal since it is traveling in the isolated direction. Due to the significant differences in detected amplitude the reverse signal can be easily ignored by the timing control unit 315.

FIG. 4C shows the output of the timing control unit 315. The timing control unit 315 samples the output power detector 310. From the samples taken, the timing control unit 315 can measure the forward signal detected width (FIG. 4B) and the forward signal rising edge period. Based on this timing information, and design knowledge about the directional coupler 305 and the power detector 310, the forward-to-reverse transition signal shown in FIG. 4C can be created with delays compensated for the signal generator 215. Note that the transition signal generated is offset in time from the detected signal. The offset shown is approximately one period less detection delay. In this example the rising edge on one forward period produces a transition signal generator rising edge for the following forward signal period. This delay could be increased by additional full periods if necessary. Also note that the timing generator forward signal pulse width is expanded. This is done to ensure that the booster 130 is optimized for forward signal transmission prior to the forward signal arriving at the booster 130 and throughout the forward signal transmission.

Those skilled in the art will appreciate that the exact timing of the rising and falling edges of the forward-to-reverse transition signal may depend on the specific booster 130 used. The timing control unit can be designed or programmed to provide for the specific booster needs. The expanded width feature show in FIG. 4C should not be considered limiting. For example, one may want to have the falling edge of the logic level signal (FIG. 4C) occur prior to the falling edge of the actual transmitted forward signal. This may be required by the booster design due to timing delays within the booster design itself. Also, forward link transmissions may vary in length even while the forward link rising edges remain periodic. In such cases the timing control unit may choose to change the logic state based on detection of the falling edge of a detected forward link transmission. In such a case, the delay from the rising edge of the actual signal to the associated rising edge of the logic signal should be much less than one period.

Those skilled in the art will appreciate that some time will be required to train the timing generator to properly create the logic level signal (FIG. 4C). This training may be augmented by prior knowledge of the TDD signal characteristics and the characteristics of the booster product. If the characteristics of the signal transmission change with respect to period or forward link transmission time, this training will have to be repeated. During initial or repeated training, the logic level for the booster will have to be set to one fixed level. It is expected that the booster will be set for constant forward link transmission during training. This characteristic however could be set by the user during equipment deployment.

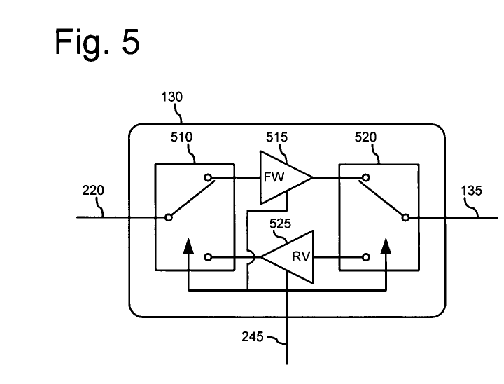

FIG. 5 shows a block diagram of an exemplary booster 130. Internally the booster includes two paths, one for the forward signal (FW) and one for the reverse signal (RV). As shown the booster 130 includes a forward amplifier 515, which is configured to boost the forward signal. In many applications, this forward amplifier 515 may not be necessary since the base station 105 could provide an adequate signal level at the antenna 140 regardless of cable losses at signal paths 110, 220 from the base station 105. In these cases, the amplifier 515 would be replaced with a simple passive transmission line (e.g. cable). The booster 130 also includes a reverse amplifier 525. This amplifier sets the noise figure of the reverse signal path and overcomes cable losses from the antenna 140 and the base station 105. Since both the forward and reverse signals alternately use the booster in TDD, switches 510, 520 are placed on either side of the signal paths. These switches 510, 520 are controlled by the synchronous logic signal provided by forward-to-reverse transition signal generator 215 on signal path 245. The synchronous logic signal from signal path 245 may also be provided to the forward and reverse amplifiers 515, 525. These amplifiers would use the synchronous logic signal to shut down operation of part or all of the active circuits within the amplifier that is not in use by the booster. By doing so, booster power consumption would be reduced, and noise generated or amplified by these amplifiers would be eliminated when not in use. Those skilled in the art will appreciate that the forward and reverse signals can be separated into two independent paths using various methods including switches and circulators, and the present invention applies to those various methods.

Advantageously, the forward-to-reverse transition signal generator 215 in accordance with embodiments of the invention can be placed near or within the booster unit. This eliminates the need for connecting the timing logic signal path 145 directly to the booster 130. This is of particular advantage when the booster 130 is not located near the base station 105. Often times, boosters are placed at or near the antenna 140 to overcome reverse link cable loss.

The present invention has been described in relation to a presently preferred embodiment, however, it will be appreciated by those skilled in the art that a variety of modifications, too numerous to describe, may be made while remaining within the scope of the present invention. Accordingly, the above detailed description should be viewed as illustrative only and not limiting in nature.

What is claimed is:

1. A transition signal generator, comprising:
a signal sampler for sampling a time division duplex signal from a signal path in a communications system;
a power detector for detecting a power of the sampled signal; and
a timing control unit for generating a logic signal indicating a direction of the sampled signal from the detected power of the sampled signal.

2. A transition signal generator as set out in claim 1, wherein the signal sampler comprises a directional coupler.

3. A transition signal generator as set out in claim 1, wherein the timing control unit generates the logic signal based on the rising or falling edge of the detected power of the sampled signal.

4. A transition signal generator as set out in claim 3, wherein the logic signal is offset in time from the edge of the detected power of the sampled signal.

5. A transition signal generator as set out in claim 4, wherein the logic signal is offset by one or more periods less a detection delay.

6. A transition signal generator as set out in claim 5, wherein the logic signal is offset by one period less the detection delay.

7. A transition signal generator as set out in claim 3, wherein the timing control unit further generates the logic signal based on the width between rising and falling edges of the sampled signal.

8. The transition signal generator as set out in claim 7, wherein the width of the logic signal is greater than the width of the sampled signal.

9. The transition signal generator as set out in claim 1, wherein the sampled signal from the signal path has a forward signal power substantially higher than a reverse signal power.

10. A wireless communication system, comprising:
a base station;
an antenna for outputting a forward signal from, or feeding a reverse signal to, the base station on a time division duplex basis;
a booster coupled between the base station and the antenna for boosting at least one of the forward and the reverse signal; and
a transition signal generator coupled to the base station and the booster to sample a time division duplex signal between the base station and the antenna and to control the booster, the transition signal generator comprising a signal sampler for sampling the time division duplex signal between the base station and the antenna, and means for generating a logic signal indicating a direction of the sampled signal to control the booster.

11. A wireless communication system as set out in claim 10, wherein the booster selectively boosts the forward signal or the reverse signal based on the logic signal generated by the transition signal generator.

12. A wireless communication system as set out in claim 10, wherein the time division duplex signal includes a forward signal, a reverse signal, and a reverse to forward gap between the forward signal and the reverse signal, and wherein the forward signal has substantially higher power than the reverse signal.

13. A wireless communication system as set out in claim 10, wherein the signal sampler comprises a directional coupler.

14. A wireless communication system as set out in claim 12, wherein the transition signal generator further comprises a power detector for detecting a power of the sampled signal.

15. A wireless communication system as set out in claim 14, wherein the power detector is a logarithmic power detector.

16. A wireless communication system as set out in claim 14, wherein the transition signal generator determines whether the signal is forward or reverse based on the detected power of the sampled signal.

17. A method for controlling a booster of a time division duplex signal between a base station and an antenna, comprising:
sampling the time division duplex signal;
determining a signal direction as being forward or reverse based on the sampled signal; and
controlling the booster based on the determined signal direction.

18. A method as set out in claim 17, wherein the time division duplex signal includes a forward signal, a reverse signal, and a reverse to forward gap between the forward signal and the reverse signal, and wherein the forward signal has a substantially higher power than the reverse signal.

19. A method as set out in claim 18, further comprising:
detecting a power of the sampled signal,
wherein determining the signal direction is based on the detected power of the sampled signal.

20. A method as set out in claim 19, further comprising:
outputting a logic signal indicating the signal direction,
wherein the logic signal timing is based on the detected power of the sampled signal.

21. A method as set out in claim 20, further comprising adjusting the logic signal timing to compensate for a delay of the sampled signal relative to the time division duplex signal.

22. A method as set out in claim 21, wherein the logic signal is offset in time from the detected power of the sampled signal.

23. A method as set out in claim 22, wherein the logic signal is offset by one or more periods less a detection delay.

24. A method as set out in claim 23, wherein the logic signal is offset by one period less the detection delay.

25. A method as set out in claim 20, wherein the logic signal is based on the width and a rising edge period of the detected power of the sampled signal.
